(19) United States
(12) Patent Application Publication
(10) Pub. No.: US 2011/0264276 A1
(43) Pub. Date: Oct. 27, 2011

(54) INTERCONNECTED ELECTRICAL NETWORK AND BUILDING MANAGEMENT SYSTEM AND METHOD OF OPERATION

(75) Inventors: A. Arthur Kressner, Westfield, NJ (US); John J. Gilbert, III, New Rochelle, NY (US); Eugene M. Boniberger, West Islip, NY (US)

(73) Assignees: RUDIN MANAGEMENT CO. INC., New York, NY (US); CONSOLIDATED EDISON COMPANY OF NEW YORK, INC., New York, NY (US)

(21) Appl. No.: 12/909,022

(22) Filed: Oct. 21, 2010

Related U.S. Application Data
(60) Provisional application No. 61/256,675, filed on Oct. 30, 2009.

(51) Int. Cl. G06F 1/32; G05D 23/19

(52) U.S. Cl. 700/276; 700/295

(57) ABSTRACT

A system for interconnecting electrical network control centers and building management systems is provided. The interconnected system monitors the operational status of the electrical network from a control center. In response to detecting the signature of an imminent electrical network event, the control center transmits a signal to the building management system. In response to receiving the signal, the building management system initiates a series of actions to mitigate or reduce the impact of the electrical network event.

### BACKGROUND OF THE INVENTION

The subject matter disclosed herein relates to a system for interconnecting an electrical power delivery network with a building management system, and in particular to a system that allows the electrical network to transmit signals to a building management system in response to a triggering event.

The electrical power delivery network, or electrical grid, is a large, complex system of interconnected elements that tie power producers, such as a power generation plant for example, with consumers. The electrical grid for one region is coupled to adjacent regions through transmission interconnections. These interconnections control and monitor the flow of electrical power between the regions. The interconnections further allow a local utility in one region to purchase power generated in another distant region.

While the electrical grid operates at a high level of reliability, due to the complexity and interconnectedness of the grid, power failures, blackouts or brownouts occasionally occur. These events may be precipitated by an issue in an adjoining region, or may be the result of excess demand that surpasses the available delivery capacity of the grid. In either case, when power is lost to the end consumer, the equipment and building systems relied upon by the consumer will generally cease to function. For example, where the end consumer is a multistory building, the sudden loss of power could result in passengers being left in elevators between floors. Generally the building owner or manager needs to have personnel inspect and manually operate the elevators to the next available level.

In an attempt to alleviate the potential for a power loss event, various government bodies have proposed or implemented regulations affecting both the electrical grid operator and the end consumer. In general, these regulatory schemes have aimed to address excess demand during peak consumption periods. In some cases these regulations have required building owners and managers to be responsible for measuring and managing the energy consumption patterns of the buildings commercial, retail and residential customers.

Accordingly, while existing electrical grid control systems and building management systems are suitable for their intended purposes a need for improvements remains, particularly regarding systems that provide an advanced warning to the building operator of issues on the electrical grid.

### BRIEF DESCRIPTION OF THE INVENTION

According to one aspect of the invention, an interconnected electrical network event system is provided. The system includes an electrical network control center configured to monitor in real-time the operation status of an electrical network. The electrical network control center further includes at least one processor responsive to executable computer instructions when executed on the processor for receiving a first signal from sensors on the electrical network and evaluating the first signal to determine if an event is imminent. If the event is imminent, the processor transmits a second signal. The system further includes a building management system operably coupled to communicate with the electrical network control center. The building management system has at least one processor responsive to executable computer instructions when executed on the processor for receiving the second signal and executing a series of predetermined actions in response to the second signal.

According to another aspect of the invention, a building management system is provided. The building management system includes a building management controller having an input for receiving a first signal from an electrical network control center. Wherein the building management controller includes a processor responsive to executable computer instructions for executing a series of predetermined actions to reduce electrical power consumption in response to receiving the first signal.

According to another aspect of the invention, a method of operating an interconnected electrical network event system is provided. The method includes the step of monitoring a plurality of sensors coupled to an electrical network. A first signal is received from each of the plurality of sensors. The first signals are evaluated. It is determined from the first signals that an electrical network event is imminent. The electrical network event is classified. A second signal is transmitted to a building management system. A series of predetermined actions is initiated in response to the second

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a electrical power network in accordance with one aspect of the invention;

FIG. 2 is an illustration of a demand curve for the electrical power network of FIG. 1;

FIG. 3 is a schematic illustration of an interconnected communications system for the electrical power network of FIG. 1;

FIG. 4 is a flow diagram illustrating the communications between an electrical power network and a building management system;

FIG. 5 is another flow diagram illustrating another embodiment of the communications between an electrical power network and a building management system; and,

FIG. 6 is another flow diagram illustrating another embodiment of the communications between an electrical power network and a building management system.

The detailed description explains embodiments of the invention, together with advantages and features, by way of example with reference to the drawings.

### DETAILED DESCRIPTION OF THE INVENTION

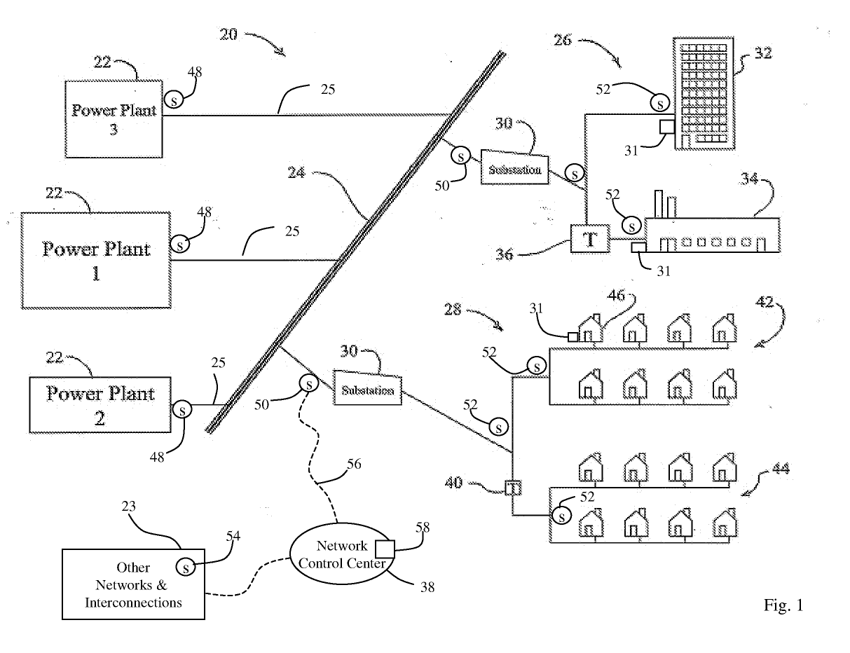

FIG. 1 illustrates an exemplary embodiment of an electrical power network 20. The electrical power network 20 includes one or more power plants 22 connected in parallel to a transmission network 25 that delivers electrical power to the main distribution network 24. The power plants 22 may include, but are not limited to: coal, nuclear, natural gas, or incineration power plants. Additionally, the power plants 22 may include one or more hydroelectric, solar, or wind turbine power plants. It should be appreciated that additional components including transformers, switchgear, fuses and the like (not shown) may be incorporated into the electrical power network 20 as needed to ensure the efficient operation of the system. The electrical power network 20 may be interconnected with one or more other regional networks via interconnection 23 to allow the transfer of electrical power into or out of the electrical power network 20.

The main distribution network 24 typically consists of medium voltage power lines, less than 50 kV for example, and associated distribution equipment which carry the electrical power from the point of production at the power plants 22 to the end users located on local electrical distribution networks 26, 28. The local electrical distribution networks 26, 28 are connected to the main distribution network 24 by substations 30 which adapt the electrical characteristics of the electrical power to those needed by the end users. Substations 30 typically contain one or more transformers, switching, protection and control equipment. Larger substations 30 may also include circuit breakers to interrupt faults such as short circuits or over-load currents that may occur. Substations 30 may also include equipment such as fuses, surge protection, controls, meters, capacitors and voltage regulators. It should be appreciated that the representations of the substations 30 is for illustration purposes and the electrical power network 20 may have additional substations as needed to deliver the electrical power.

The substations 30 connect to one or more local electrical distribution networks, such as local electrical distribution network 26, for example, that provides electrical power to a commercial area having end users such as an office building 32 or a manufacturing facility 34. As will be discussed in more detail below, these commercial buildings may have a building management system 31 that controls various subsystems within the office building 32 or manufacturing facility 34. Local electrical distribution network 26 may also include one or more transformers 36 which further adapt the electrical characteristics of the delivered electricity to the needs of the end users. Substation 30 may also connect with other types of local distribution networks such as residential electrical distribution network 28. The residential electrical distribution network 28 may include one or more residential buildings 46 and also light industrial or commercial operations. Similar to the commercial buildings, the residential buildings may also have a building management system to assist them in understanding and controlling their electrical usage.

The electrical power available to an end user on one of the local electrical distribution networks 26, 28 will depend on number of factors including the generation capacity of power plants 22, the operational status of interconnection 23 and transmission network 25, the characteristics of local distribution network and the location of the end user on the local network. For example, local electrical distribution network 28 may include one or more transformers 40 that further divides local electrical distribution network 28 into two sub-networks 42, 44. One such electrical characteristic is the maximum power that may be delivered to a local distribution network. While the electrical power network 20 may have power plants 22 capable of generating many megawatts of electrical power, this power may not be completely available to an end user in a residence 46 on a local electrical distribution network 28 since the intervening equipment and cabling restrictions, or limits the delivery of electrical power.

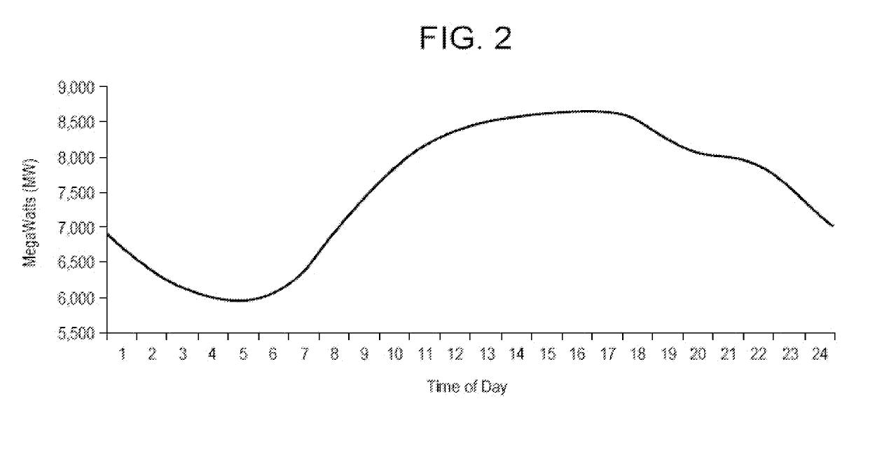

Existing local electrical distribution networks 26, 28 are designed to provide the electrical power demanded during peak usage periods. Referring to FIG. 2, it can be seen that the demand for electrical power does not remain constant during the day, but rather peaks in the late afternoon/early evening. The demand curve illustrated in FIG. 2 is an average electrical demand for a large metropolitan city. The actual demands on the local distribution network will change from one day to the next and will also differ depending on the season. The actual demand will be the function of many parameters, including the weather, time of day, season of the year and the like. Further if a local electrical distribution network 26, 28 experiences an increase in electrical demand due to other factors, such as new construction for example, changes may need to be made to the local distribution network to allow sufficient power to flow to the local distribution network, even though the electrical network 20 has sufficient electrical production capacity to meet the needs of the new demand.

The flow of electrical power within the electrical power network 20 is controlled by one or more network control centers 38. It should be appreciated that while a single control center 38 is illustrated, the electrical power network 20 may include a plurality of control centers that are interconnected and cooperate to deliver electrical power to the end consumer. The control center 38 is connected to sensors 48, 50, 52, 54 that allow the control center to monitor the real-time operation of the electrical power network 20. These sensors may include generation and transmission sensors 48, substation sensors 50, local distribution sensors 52 and interconnection sensors 54. These sensors 48, 50, 52, 54 include, but are not limited to phasor measurement units (PMU), power demand meters, voltage meters, thermocouples, phase angle meters, current meters and the like. The sensors 48, 50, 52, 54 are coupled to the control center 38 by any known communication network 56, including but not limited to a wide area network (WAN), a public switched telephone network (PSTN) a local area network (LAN), a global network (e.g. Internet), a virtual private network (VPN), and an intranet. The communication network 56 may be implemented using a wireless network or any kind of physical network implementation known in the art. The sensors may be coupled to the control center 38 through multiple networks (e.g., intranet and Internet) so that not all sensors are coupled through the same network. Furthermore, the sensors may be connected to the control center 38 by a combination of a PSTN and the Internet, for example. One or more sensors and the control center 38 may be connected to the communication network 56 in a wireless fashion. As will be discussed in more detail below, communication network 56 further connects the control center 38 to building management system 31.

The control center 38 may include one or more processing systems 58. The processing system 58 has one or more central processing units (processors). Processors are coupled to system memory and various other components via a system bus. Read only memory (ROM) is coupled to the system bus and may include a basic input/output system (BIOS), which controls certain basic functions of processing system 58. The processing system 58 may further include an input/output (I/O) adapter and a network adapter coupled to the system bus. I/O adapter may be a small computer system interface (SCSI) adapter that communicates with a hard disk and/or tape storage drive or any other similar component. A network adapter interconnects the system bus with communication network 56 enabling processing system 58 to communicate with other such systems, such as building management system 31. One or more screens (e.g., a display monitor) are connected to the system bus by a display adaptor. Additional input/output devices may be connected to the system bus via user interface adapter and a display adapter. A keyboard, mouse, and speaker are all interconnected to the bus.

It will be appreciated that the processing system 58 can be any suitable computer or computing platform, and may include a terminal, wireless device, information appliance, device, workstation, mini-computer, mainframe computer, personal digital assistant (PDA) or other computing device. It shall be understood that the processing system 58 may include multiple computing devices linked together by a communication network. For example, there may exist a client-server relationship between two systems and processing may be split between the two.

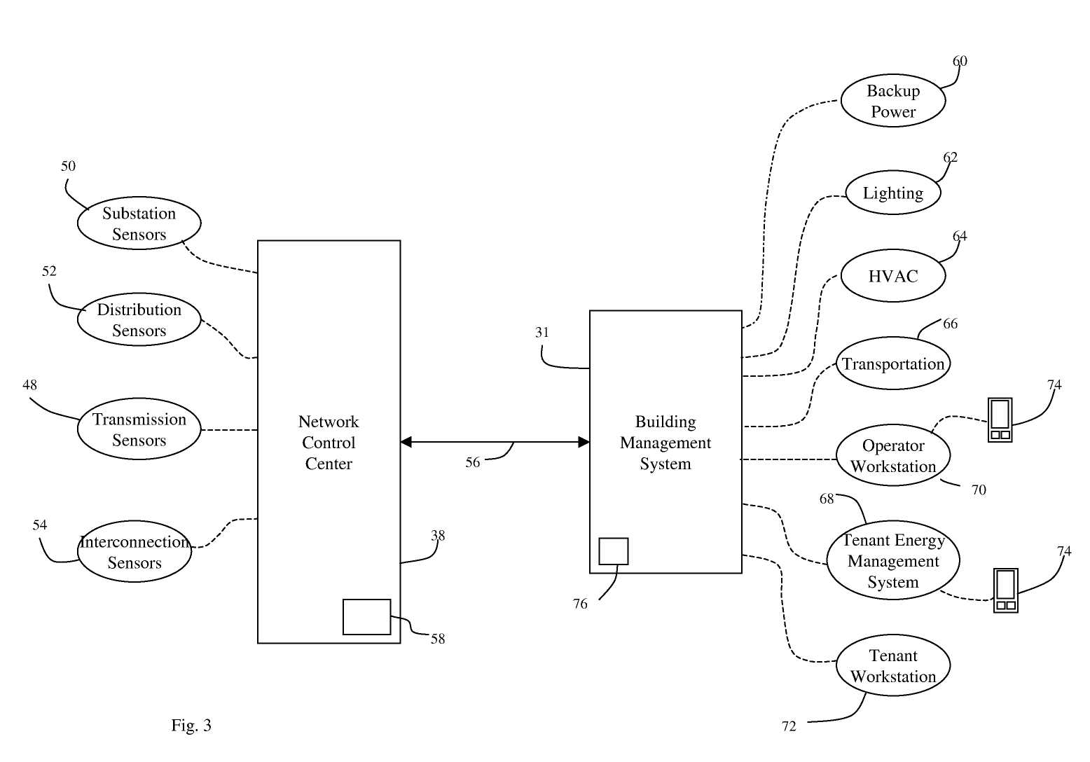

Referring now to FIG. 3, the interconnection between the control center 38 and the building management system 31 will be described. It should be appreciated that while a single building management system 31 is illustrated herein, this is for exemplary purposes and the claimed invention should not be so limited. The building management system 31 may also be comprised of several systems, or may control multiple buildings or facilities for example.

As discussed above, building management system 31 provides a building owner a centralized control platform for the various subsystems within a building, such as a commercial office building 32 for example. These subsystems may include but are not limited to, backup power generation systems 60, lighting systems 62, heating, ventilation and air conditioning systems (HVAC) 64, transportation systems 66 (e.g. escalators and elevators), and a tenant energy management system 68. The building management system 31 may further be arranged to communicate with an operator workstation 70 and a tenant workstation 72. The operator workstation 70 and tenant workstation 72 provide an interface for the building manager and the tenant respectively. The operator workstation 70 and tenant workstation 72 may be any suitable computer or computing platform, and may include a terminal, wireless device, information appliance, device, workstation, mini-computer, mainframe computer, personal digital assistant (PDA), cellular phone, or other computing device. In one embodiment, the building management system 31 is further configured to communicate with a wireless device, such as a cellular phone 74 for example.

The building management system 31 also includes a processing system 76 having one or more central processing units (processors). Processors are coupled to system memory and various other components via a system bus in a similar manner to that described above with respect to processing system 58. It should be appreciated that building management system 31 may be any suitable computer or computing platform, and may include a terminal, wireless device, information appliance, device, workstation, mini-computer, mainframe computer, personal digital assistant (PDA), cellular phone, or other computing device.

In the exemplary embodiment, the building management system 31 is a supervisor control and data acquisition system (SCADA) capable to altering the operation of the subsystems 60, 62, 64, 66 to meet desired performance characteristics. For example, the building management system 31 may be coupled to thermostats to allow an automatic change in temperature. This could allow the building management system 31 to reduce energy consumption by increasing the temperature by a few degrees during the summer such that the air conditioning system is not operated as often.

The control center 38 is coupled to transmit signals to the building management system 31 via communication network 56. This interconnection of the control center 38 and building management system 56 allow the electrical power network 20 and buildings 32, 34, 46 to cooperate in response to anticipated electrical network events. Advantages may be gained by initiating corrective actions prior to the electrical network event to either eliminate the event (e.g. lower demand) or reducing its impact (e.g. stopping elevators at the closest floor).

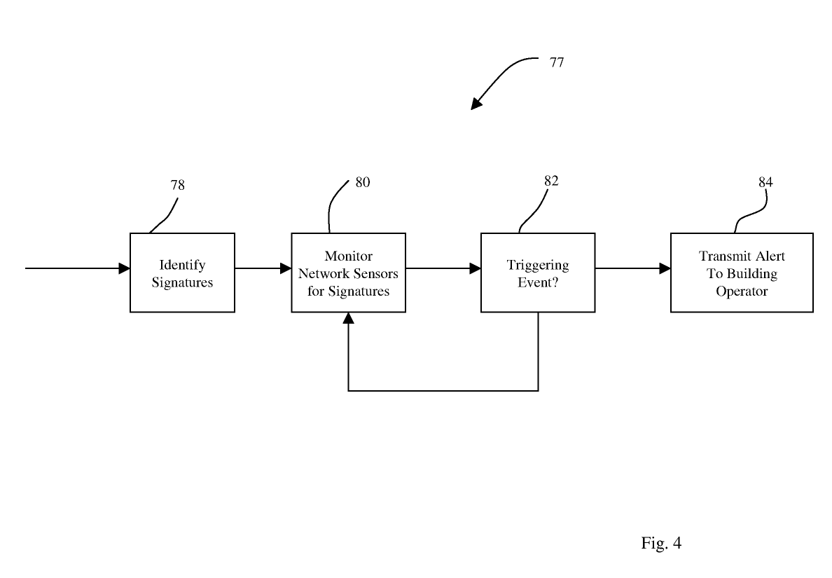

One embodiment for a method 77 of operating the interconnected electrical power network 20 and building management system 31 is illustrated in FIG. 4. In this embodiment, the control center 38 identifies signatures 78 from the sensors 48, 50, 52, 54 that indicate an imminent electrical network event is about to occur. These signatures may be determined from historical data or acquired during operation and stored for future use. One example of a signature would be the detection of loop flows at the interconnection 23. Loop flows occur when the path over which power physically flows does not correspond to the path over which the power was scheduled to flow. This may cause a congestion situation at the interconnection 32 that results in an overloading of one or more transmission lines. In some limited circumstances, the transmission lines may become inoperable from the overload causing the electrical power to be shifted to the remaining transmission circuits. In a cascading effect, the transmission lines may become inoperable or be disconnected to protect the conductors from damage, resulting in a widespread power outage.

Other examples of a signature could include but are not limited to an actual demand curve having a peak demand that deviates significantly from an expected peak demand or a loss of delivery capacity either through the loss of a transmission line or a power plant 22 for example.

While these types of events may occur very rapidly, it has been found that signatures of the impending event are detectable 15-30 seconds before the event occurs. In some cases, the precedent conditions may be detected several hours before the event. Once these signatures are identified, the method 77 proceeds to monitor 80 the electrical power network 20 for these event signatures. If a triggering event 82 occurs (e.g. loop flow conditions, excess demand), a signal is transmitted 84 from the control center 38 to the building management system 31. As will be discussed in more detail below, once the alert signal is received, the building management system 31 can initiate a number of processes to offset or alleviate the electric network event, such as but not limited to, stopping elevators at the closest floor, starting backup/emergency power generation systems, modulating lights, reducing HVAC electrical loads, visual and audible alarms to the building operator.

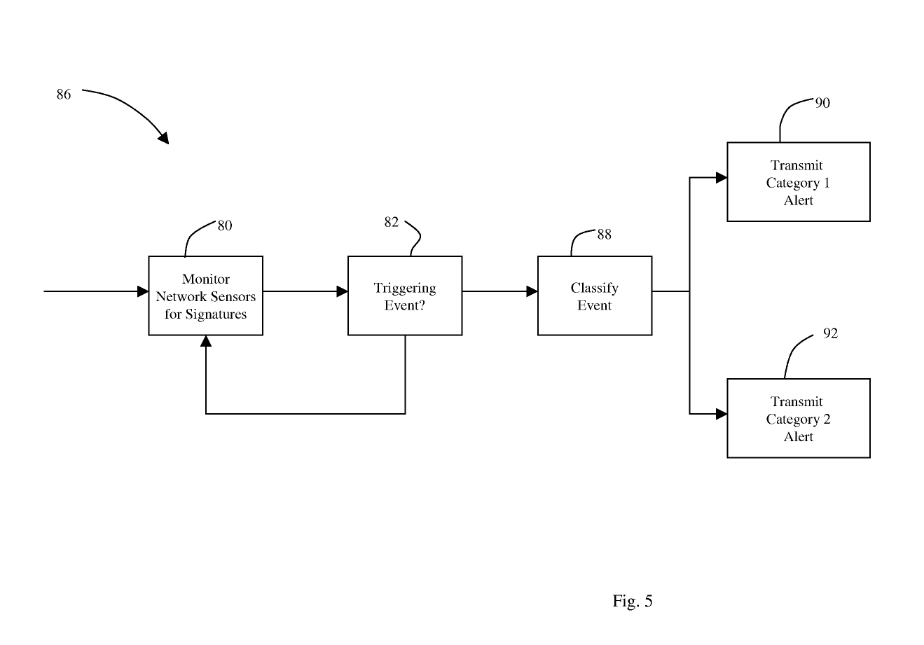

Another embodiment of a method 86 for operating the interconnected electrical power network 20 and building management system 31 is illustrated in FIG. 5. In this embodiment, the method monitors 80 and identifies a triggering event 82 as discussed above. After the triggering event is identified, the method 86 classifies 88 the event. It should be appreciated that different types of events are responded to in a different manner by both the control center 38 and the building management system 31. Therefore, in this embodiment the control center 38 may transmit a category 1 alert 90 or category 2 alert 92 depending on the type of event that is occurring.

In the exemplary embodiment, the category 1 alert represents a situation where a wide spread power loss is imminent. It should be appreciated that while a power loss such as that precipitated by a loop flow occurs only rarely, by addressing the event in an expedited fashion will provide advantages in situations such as having elevators stop between floors. As there is little the building operator can do to stop or prevent a condition such as a loop flow, a category 1 alert cause the building management system 31 to initiate mitigation procedures to reduce the impact on the building and its occupants. A category 2 alert in contrast is one in which the building management system 31 may cooperate with the control center 38 to alleviate the underlying condition, such as a excess demand or a demand that exceeds available capacity for example. With reference to FIG. 1, if the control center 38 detects that the demand on local electrical distribution network 26 exceeds the ability of the network to deliver sufficient electrical power, a category 2 alert could be transmitted to building management systems 31 associated with local electrical distribution network 26. If several of the office buildings 32 on local electrical distribution network 26 promptly reduce their electrical loads by increasing thermostat temperatures and turning off unnecessary lights, the demand may be reduced to less than the available capacity.

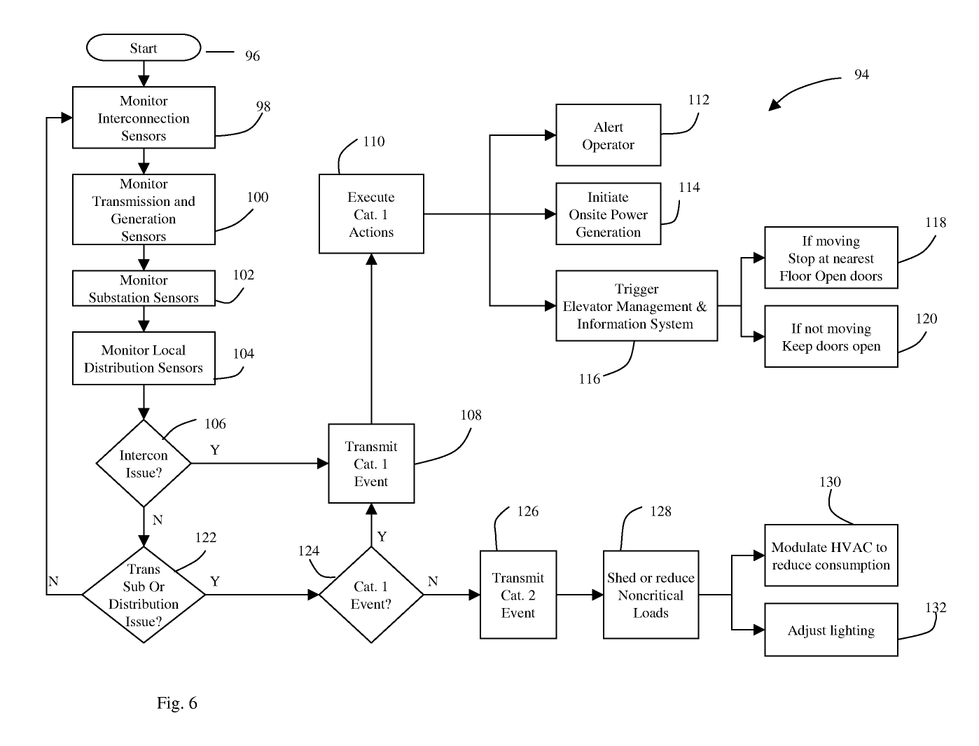

Another embodiment of a method 94 of operating an interconnected electrical network control center 38 and building management system 31 is shown in FIG. 6. In this embodiment, the method 94 starts in block 96 and proceeds to monitor the interconnection sensors 54 in block 98, the generation and transmission sensors 48 in block 100, the substation sensors 50 in block 102 and the local distribution sensors 52 in block 104. It should be appreciated that the monitoring of the sensors 48, 50, 52, 54 may also occur simultaneously.

The method 94 then proceeds to query block 106 where it is determined if there is an issue with the interconnection 23, such as a loop flow for example. If query block 106 returns a positive, the method 94 proceeds to block 108 where a category 1 alarm signal is transmitted to the building management system 31. The building management system 31 then executes category 1 actions in block 110. These actions include alerting the operator in block 112, initiating onsite generation of power in block 114, and triggering the elevator management and information system (EMIS) in block 116. The EMIS evaluates each of the elevators in the building and where the elevator is moving, the EMIS moves the elevator to the nearest floor and opens the doors in block 118. If the EMIS determines that the elevator is not moving, the elevator doors are moved to the open position in block 120.

If query block 106 returns a negative the method 94 proceeds to query block 122 where it is determined if there is any issue in the transmission, substation or distribution portions of the electrical power network 20. If query block 122 returns a negative, the method 94 loops back to block 98 and repeats the process of monitoring the sensors. If query block 122 returns a positive the method 94 proceeds to query block 124 where it is determined if this is a category 1 type of event. For example, equipment malfunction at a major substation may have the effect of creating imminent, wide spread power loss. If it is determined that the event is a category 1 event, then the method 94 loops to block 108 and transmits the category 1 alarm signal as described above.

If it is determined that the event is not a category 1 type of event, then the method 94 proceeds to block 126 where the category 2 alarm signal is transmitted to the building management system 31. Upon receiving the category 2 signal, the building management system 31 executes actions to shed or reduce non-essential loads with in the building in block 128. These actions may include modulating the HVAC systems in block 130, such as by adjusting thermostats for example, and adjusting the lighting system in block 132.

It should be appreciated that the use of two categories of events is for illustration purposes and the claimed invention should not be so limited. The interconnected control center and building management system may have several different categories or layers of events with actions that are tailored to accommodate or mitigate the electrical network event.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to mitigate or avoid network events such as power loss to end users through the cooperation of a network control center and building management systems.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electrical network event system comprising:
an electrical network control center configured to monitor in real-time an operation status of an electrical network, the electrical network control center further having a first processor responsive to executable computer instructions when executed on the first processor for receiving a first signal from sensors on the electrical network, and evaluating the first signal to determine if an event is imminent;
wherein the first processor is configured for transmitting a second signal in response to determining the event is imminent to a remote building management system for executing a series of predetermined actions.

2. The electrical network event system of claim 1 wherein the remote building management system operably coupled to communicate with the electrical network control center, the remote building management system further having a second processor responsive to executable computer instructions when executed on the second processor for receiving the second signal and executing a first series of predetermined actions in response to the second signal.

3. The electrical network event system of claim 2 wherein the first series of predetermined actions is chosen from a group comprising: stopping elevators at a nearest floor, adjusting a building heating ventilation and air conditioning system, initiating operation of a backup power system, and adjusting a lighting system.

4. The electrical network event system of claim 3 wherein the second processor is further responsive to executable computer instructions for transmitting an alert signal to a building operator in response to the second signal.

5. The electrical network event system of claim 2 wherein the first processor is further responsive to executable computer instructions when executed on the first processor for categorizing the event and transmitting the second signal when the event is a first category event and a third signal to the remote building management system when the event is a second category event.

6. The electrical network event system of claim 5 wherein the second processor is further responsive to executable computer instructions when executed on the second processor for receiving the third signal and executing a second series of predetermined actions in response to the third signal.

7. The electrical network event system of claim 6 wherein the second series of predetermined actions is chosen from a group comprising: reducing a number noncritical electrical loads, modulating heating ventilation and air conditioning systems, increasing thermostat temperatures, and turning off lights.

8. The electrical network event system of claim 7 wherein the first series of predetermined actions is chosen from a group comprising: stopping elevators at a nearest floor, initiating operation of a backup power system, and alerting a building operator.

9. A building management system comprising:
a building management controller having an input for receiving a first signal from an electrical network control center;
wherein the building management controller includes a processor responsive to executable computer instructions for executing a series of predetermined actions to reduce electrical power consumption in response to receiving the first signal.

10. The building management system of claim 9 wherein the series of predetermined actions is chosen from a group comprising: stopping elevators at a nearest floor, adjusting a building heating ventilation and air conditioning system, initiating operation of a backup power system, and adjusting a lighting system.

11. The building management system of claim 10 wherein the building management controller is further configured for receiving and transmitting signal to a plurality of building subsystems, the plurality of building subsystems includes at least one of a backup power system, a lighting system, a heating ventilation and air conditioning system, a transportation system and a tenant energy management system.

12. The building management system of claim 9 wherein the series of predetermined actions includes a first series of predetermined actions and a second series of predetermined actions.

13. The building management system of claim 12 wherein the processor is further responsive to executable computer instructions for executing the first series of predetermined actions to reduce electrical power consumption in response to receiving the first signal.

14. The building management system of claim 13 wherein the first series of predetermined actions is chosen from a group comprising: stopping elevators at a nearest floor, initiating operation of a backup power system, and alerting a building operator.

15. The building management system of claim 13 wherein the processor is further responsive to executable computer instructions for executing the second series of predetermined actions to reduce electrical power consumption in response to receiving a second signal.

16. The building management system of claim 15 wherein the second series of predetermined actions is chosen from a group comprising: reducing a number noncritical electrical loads, modulating heating ventilation and air conditioning systems, increasing thermostat temperatures, and turning off lights.

17. A method of operating an interconnected electrical network event system comprising:
monitoring a plurality of sensors coupled to an electrical network;
receiving a first signal from each of the plurality of sensors;
evaluating the first signal;
determining from the first signal that an electrical network event is imminent; and,
transmitting a second signal to a building management system.

18. The method of claim 17 further comprising initiating a series of predetermined actions in response to the second signal, wherein the series of predetermined actions is chosen from a group comprising: stopping elevators at a nearest floor, adjusting a building heating ventilation and air conditioning system, initiating operation of a backup power system, and adjusting a lighting system.

19. The method of claim 17 further comprising:
classifying the electrical network event as a first category event or a second category event;
transmitting the second signal when the electrical network event is the first category event; and,
transmitting a third signal to the building management system when the electrical network event is the second category event.

20. The method of claim 19 further comprising:
initiating a first series of predetermined actions in response to the second signal, wherein the first series of predetermined actions is chosen from a group comprising: stopping elevators at a nearest floor, initiating operation of a backup power system, and alerting a building operator; and,
initiating a second series of predetermined actions in response to the third signal, wherein the second series of predetermined actions is chosen from a group comprising: reducing a number noncritical electrical loads, modulating heating ventilation and air conditioning systems, increasing thermostat temperatures, and turning off lights.
